(19) United States
(12) Patent Application Publication
(10) Pub. No.: US 2007/0010935 A1
(43) Pub. Date: Jan. 11, 2007

(54) System and process for adjusting a zero point of a seat load sensing system

(75) Inventors: Walid Aldeeb, Ypsilanti, MI (US); Raymond J. David, Dearborn Heights, MI (US); Christopher J. Hibner, Canton, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/177,656

(22) Filed: Jul. 8, 2005

(51) Int. Cl. G06F 17/10

(52) U.S. Cl. 701/124

(57) ABSTRACT

A process for adjusting the zero point of a system (10) for sensing weight on a seat (12) of a vehicle includes the steps of correcting only negative zero points errors during an ignition cycle of the vehicle and correcting positive zero point errors after the vehicle ignition cycle ends.

### TECHNICAL FIELD

The present invention relates to a system for sensing a load on a vehicle seat and, more particularly, to a system and process for adjusting a zero point of the seat load sensing system.

### BACKGROUND OF THE INVENTION

A vehicle occupant protection device, such as an air bag for an occupant of a vehicle seat, may be disabled if it is determined that an occupant of the seat is under a certain weight. Seat weight sensing systems that determine the weight or load on the vehicle seat may include weight sensors that are mounted on or in the vehicle seat. The seat weight sensing systems may distinguish between the weight of an adult seated on the seat, of a child seated on the seat, and of a child seat cinched down tight on the vehicle seat. In response to making this distinction, the seat weight sensing system may permit, inhibit, or tailor actuation of the protection device.

The “zero point” of a seat weight sensing system relates to the weight sensed by the system when there is no load on the seat. The seat weight sensor of the seat weight sensing system has a zero load output when there is no load on the seat. The seat weight sensing system is calibrated to associate a weight of zero with the zero load output of the seat weight sensor. Over time, the zero load output of the seat weight sensor may vary due to factors, such as drift in the seat weight sensor output signal per se, fatigue in the seat structure, or fatigue in other vehicle structures. As a result, the seat weight sensing system may read a positive or negative non-zero weight value when there is no load on the seat. This may be referred to as a “zero point error.”

A zero point of a seat weight sensing system may be adjusted to compensate for a zero point error that falls within a predetermined range when sensed conditions indicated that the vehicle seat is unloaded. For example, the predetermined range may be −4 kg to +4 kg. In one process, the system detects a zero point error at a predetermined time after completing an ignition cycle of the vehicle when sensed conditions indicate that the seat is likely to be unloaded. For example, at a predetermined time after an ignition cycle (i.e., after the vehicle ignition system is deactivated), the system may detect an unloaded seat if the following conditions are satisfied: the sensed weight is within the small range (e.g., −4 kg to +4 kg), the seatbelt is unlatched, and there have been no weight fluctuations for a predetermined period of time (e.g., 15 minutes). If, a zero point error is detected after all of these conditions are met, the system adjusts the zero point of the system to help correct the error. This can be done by adjusting the zero point to correct the entire error, a portion (e.g., half) of the error, or a portion of the error up to a maximum value (e.g., up to 1 kg).

A problem may occur where the seat weight sensor has a negative zero point error within the predetermined range and an object having a weight outside the correctable range is placed on the seat. For example, if a zero point error causes the system to sense −1.5 kg and a 5 kg object, such as a briefcase, is placed on the seat, the sensed weight would go positive to +3.5 kg, which may be within the correctable range. If the object is left on the seat for an extended period, the system may, over time, correct the zero point with the object on the seat. When the object is removed, the sensor would read negative (−5 kg), which is outside the correctable range. This may result in no subsequent zero-point adjustments taking place. This may also result in a flag being set in a vehicle diagnostics system, triggering an alarm, such as a warning light on an instrument panel, which requires servicing by a qualified technician.

### SUMMARY OF THE INVENTION

In accordance with the present invention, a process for adjusting the zero point of a system for sensing weight on a seat of a vehicle includes the steps of correcting only negative zero points errors during an ignition cycle of the vehicle and correcting positive zero point errors after the vehicle ignition cycle ends.

Also, in accordance with the present invention, a process for adjusting the zero point of a system for sensing weight on a seat of a vehicle includes the step of determining a sensed load on the vehicle seat without regard to whether the seat is occupied. The process also includes the step of determining a negative zero point error in response to determining a negative sensed weight on the vehicle seat. The process also includes the step of zeroing the sensed weight in response to determining the negative zero point error. The process further includes the step of repeating the steps of determining a sensed load, determining a negative zero point error, and zeroing the sensed weight throughout an ignition cycle of the vehicle.

Further, in accordance with the present invention, a vehicle seat weight sensing system includes a seat weight sensor associated with a vehicle seat. The system also includes a controller operative to determine a sensed weight on the vehicle seat in response to an output from the seat weight sensor. The controller includes means for correcting only negative zero points errors during an ignition cycle of the vehicle. The controller also includes means for correcting positive zero point errors after the vehicle ignition cycle ends.

### BRIEF DESCRIPTION OF THE DRAWINGS

The foregoing and other features and advantages of the invention will become apparent to one skilled in the art upon consideration of the following description of an exemplary embodiment of the invention and the accompanying drawings, in which:

FIG. 1 is a block diagram of a system in accordance with the present invention; and

FIGS. 2-4 are flow charts illustrating steps of processes that may be performed by the system of FIG. 1.

### DESCRIPTION OF EMBODIMENTS

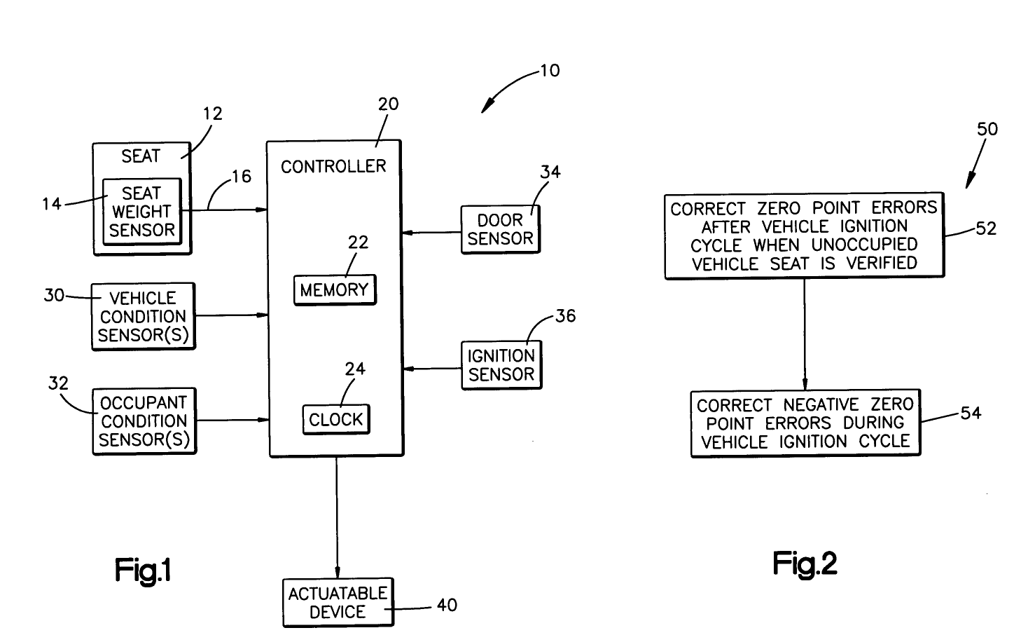

As representative of the present invention, FIG. 1 illustrates a system 10 in accordance with the present invention. The system 10 includes a vehicle seat indicated schematically at 12, such as a front passenger seat of a vehicle (not shown). The system 10 also includes a seat weight sensor 14 that provides an output 16 to a controller 20 via means, such as lead wires. The output 16 of the seat weight sensor 14 is related to the load or weight on the vehicle seat 12.

The seat weight sensor 14 can be any known device used to provide an output related to the load or weight on the vehicle seat 12. For example, the seat weight sensor 14 may comprise one or more strain gauges, pressure pattern sensors, or pressure bladders. In one embodiment, the seat weight sensor 14 comprises strain gauges arranged in a Wheatstone bridge on a load bearing member of a seat frame structure. The seat weight sensor 14 may be responsive to loads or weight on the seat 12 over a large range, with relatively high sensitivity. For example, the seat weight sensor 14 may be responsive to loads or weights up to 100 kilograms or more with a one-tenth kilogram (0.10 kg) sensitivity.

The system 10 may also include one or more vehicle condition sensors 30 that are operative to provide outputs related to sensed vehicle conditions. For example, the vehicle condition sensors 30 may include vehicle crash sensors, rollover sensors, or both in which the outputs are related to the occurrence of vehicle events, such as a vehicle collision, a vehicle rollover, or both.

The system 10 may also include one or more occupant condition sensors 32 that are operative to provide to the controller 20 outputs related to sensed occupant conditions. For example, the occupant condition sensors 32 may include a seatbelt latch sensor for which the output is related to the latched condition of a seatbelt of the vehicle seat 12. As another example, the occupant condition sensors 32 may include seat position sensor for which the output is related to the position (e.g., forward/rearward) of the vehicle seat 12. As a further example, the occupant condition sensors 32 may include pressure switches or ultrasonic transducers for which the output is indicative of the presence or position of an occupant.

The system 10 may also include a vehicle door sensor 34 (e.g., a switch) that is operative to provide to the controller 20 an output related to an opened/closed condition of a vehicle door. The system 10 may further include a vehicle ignition sensor 36 that is operative to provide to the controller 20 an output related to an activated/de-activated condition of a vehicle ignition.

The system 10 may also include an actuatable device 40, such as an actuatable device for helping to protect an occupant of the vehicle seat 12. The actuatable devices may, for example, be an inflator for an air bag, an inflator for a side curtain, an actuator for a knee bolster, or an actuator for a seat belt retractor. The actuatable device 40 is actuatable in response to an output 22 from the controller 20.

The controller 20 is operative to control actuation of the actuatable device in response to the outputs of the seat weight sensor 14, vehicle condition sensors 30, occupant condition sensors 32, or a combination of these sensors. For example, the controller 20 may be operative to actuate the actuatable device 40 in a known manner in response to receiving an output from the vehicle condition sensors 30 indicative of the occurrence of an event for which occupant protection is desired, such as a collision or a rollover. In one instance, the controller 20 may tailor or inhibit actuation of the actuatable device 40 in response to the outputs from the seat weight sensor 14 and/or occupant condition sensors 32. In another instance, the controller 20 may inhibit actuation of the actuatable device 40 in response to the outputs of the seat weight sensor 14 indicating a weight on the vehicle seat 12 below a predetermined minimum. As another example, the controller 20 may tailor actuation of the actuatable device 40 in response to the outputs of the seat weight sensor 14 and occupant condition sensor 32 indicating an unbelted occupant in the vehicle seat 12.

The system 10 may also include memory 22, which may be part of the controller 20. The memory 22 may be of a type, such as (non-volatile memory (NVM), that is operative to store data, even when the vehicle ignition is deactivated, as to whether the actuatable device 40 is enabled or disabled. The system 10 may also include a clock or timer 24, which may be part of the controller 20.

An ignition cycle of the vehicle begins when the vehicle ignition is activated and ends when the vehicle ignition id deactivated. Upon activation of the vehicle ignition, the system 10 initializes, for example, by executing a diagnostics procedure. The initialization may be performed quickly, such as in less than a second after the vehicle ignition is activated. Once the system initialization is complete, the controller 20 is operative to receive the output 16 of the seat weight sensor 14 and determine a sensed seat weight responsive to the output. The controller 20 is also operative to adjust the zero point of the seat weight sensing system 10 to help correct zero point errors in the system.

It will be appreciated that negative sensed weights may be accurate only in rare circumstances, such as where an object becomes stuck or wedged under the vehicle seat 12. Because of this rarity, according to the present invention, negative sensed weights can be identified as zero point errors with a relatively high degree of certainty and, thus, can be corrected without further verification. Positive sensed weights, however, in and of themselves, carry a significantly lower degree of certainty because of the relatively high degree of likelihood that positive sensed weights are accurate. For example, an object placed on the vehicle seat may result in a small positive sensed weight that is accurate, i.e., not a zero point error. Because of this, it may be desirable to increase the certainty with which a positive sensed weight is considered as a zero point error. According to the present invention, positive zero points are identified as being correctable zero point errors after verification.

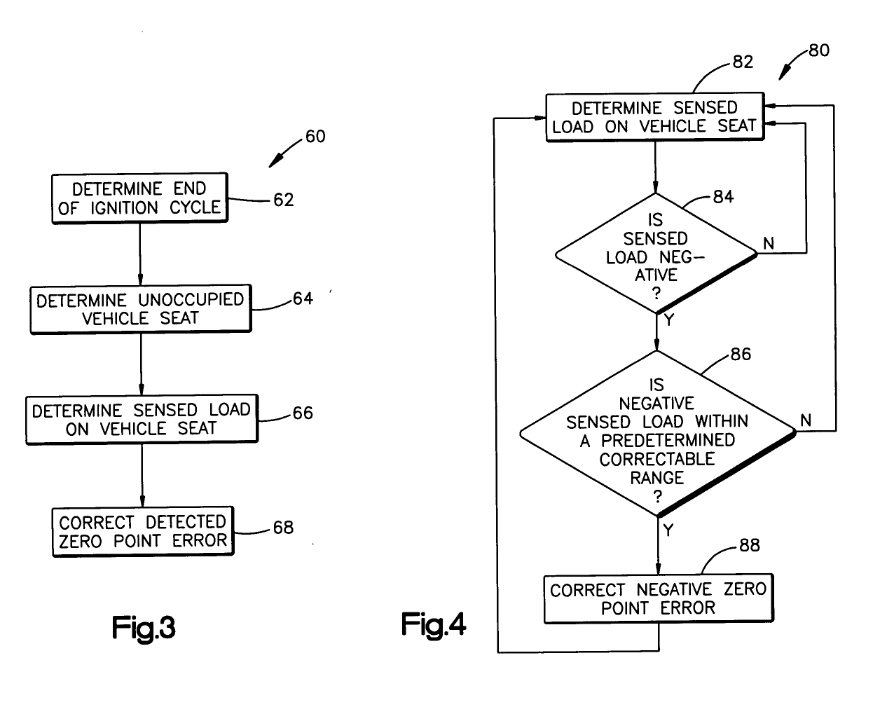

FIG. 2 is a flow diagram illustrating a process performed by the system 10 of FIG. 1 according to the present invention. The process of FIG. 2 is implemented in the controller 20. At step 52 of the zero point adjustment process 50, zero point errors are corrected after vehicle ignition cycles when an unoccupied vehicle seat is verified. As described below, at step 52, sensed weights (positive or negative) within a predetermined range are determined to be zero point errors only after an unoccupied condition of the vehicle seat 12 is verified by the system 10. At step 54 of the process 50, negative zero point errors are corrected during vehicle ignition cycles. As described below, at step 54, negative sensed weights within a predetermined range are considered zero point errors without verifying whether the vehicle seat is occupied.

FIG. 3 is a flow diagram illustrating a process performed by the system 10 of FIG. 1 according to the present invention. More particularly, the process of FIG. 3 details performed within step 52 of the process 50 of FIG. 2. The process of FIG. 3 is implemented in the controller 20 and performs adjustments of the zero point to help correct zero point errors in the seat weight sensing system 10.

Referring to FIG. 3, at step 62 of the process 60, the end of a vehicle ignition cycle is determined. This determination may be made via the ignition sensor 36 (FIG. 1). At step 64 an unoccupied condition of the vehicle seat 12 is determined. This determination may be made in a variety of manners. For example, the unloaded condition of the vehicle seat 12 may be determined by inference through vehicle condition data collected in a known manner. For instance, the unloaded condition of the vehicle seat 12 may be determined if a seatbelt associated with the seat is unlatched, the vehicle ignition has remained inactive for a predetermined period of time, and there have been no fluctuations in sensed weight on the seat for a predetermined period of time (e.g., 15 minutes). As another example, the unloaded condition of the vehicle seat 12 may be determined through positive indication. For instance, an ultrasonic transducer may be used to positively verify the unloaded condition of the vehicle seat 12.

Having determined an unoccupied vehicle seat at step 64, the process 60 determines a sensed load on the vehicle seat 12 at step 66. At step 68, a detected zero point error is corrected. The zero point error may be detected, for example, if the sensed load determined at step 66 is within a small range, such as −4 kg to +4 kg. This may be done in a variety of manners. For example, the entire zero point error may be corrected, a portion (e.g., half) of the zero point error may be corrected, or a portion of the zero point error up to a predetermined amount (e.g., 1.0 kg) may be corrected.

The zero point error correction process 60 described above corrects zero point errors after a vehicle ignition cycle when an unloaded condition of the vehicle seat 12 is detected. Thus, the zero point error correction process 60 does not take place during operation of the vehicle. According to the present invention, the system 10 is adapted to correct certain zero point errors during operation of the vehicle, i.e., during the ignition cycle of the vehicle.

FIG. 4 is a flow diagram illustrating a process performed by the system 10 of FIG. 1 according to the present invention. More particularly, the process of FIG. 4 details steps performed within step 54 of the process 50 of FIG. 2. The process of FIG. 4 is implemented in the controller 20 and performs adjustments of the zero point to help correct certain zero point errors in the seat weight sensing system 10.

Referring to FIG. 4, the zero point adjustment process 80 begins at step 82 at a predetermined time, such as upon activation of the vehicle ignition (i.e., upon beginning an ignition cycle). This may be indicated, for example, by the ignition sensor 36 (FIG. 1 ) of the system 10. At step 82, a sensed load on the vehicle seat 12 is determined via the seat weight sensor 14. Once the sensed load is determined, the process 80 proceeds to step 84, where a determination is made as to whether the sensed load is negative, i.e., less than zero. This determination may require that the sensed load remain negative for a predetermined amount of time, such as 0.5 seconds, in order to help eliminate the effects of road bumps or vehicle vibrations. If the sensed load is not negative, the process 80 reverts to step 82 and continues.

A negative sensed load determination at step 84 may be indicative of a negative zero point error. At step 84, if the sensed load is determined to be negative, the process 80 proceeds to step 86, where a determination is made as to whether the negative sensed load is within a predetermined correctable range. For example, a negative sensed load may correctable if it is less than zero and greater than or equal to negative ten kilograms (<0 kg and ≧−10 kg). If the negative sensed load is not within the correctable range, the process 80 reverts to step 82 and continues.

At step 86, if the negative sensed load is determined to be within the correctable range, a negative zero point error is determined, and the process 80 proceeds to step 88, where the entire negative zero point error is corrected, i.e., the sensed weight is set to zero. Alternatively, at step 88, a portion of the negative zero point error may be corrected. For example, a percentage of the negative zero point error, such as half, may be corrected. As another example, a portion of the negative zero point error up to a predetermined maximum, such as 1.0 kg, may be corrected.

After the zero point error is corrected at step 88, the process 80 reverts to step 82 and continues. The process 80 thus may operate continually during an ignition cycle of the vehicle. Alternatively, the process 80 may operate at intermittent periods during the ignition cycle. It will be appreciated that there may be some portion of an ignition cycle during which the process 80 may not be performed, such as during an initialization period of the system 10 immediately following the start of an ignition cycle.

From the above description, it will be appreciated and understood that the system and process of the present invention may correct zero point errors, both positive and negative, that fall within a predetermined range, such as from −4.0 kg to +4.0 kg when an unoccupied seat is verified after a vehicle ignition cycle. The system and process may also correct negative zero point errors that fall within a larger range, such as from zero to −10 kg during the vehicle ignition cycle because of the higher degree of certainty that may be attributed to negative sensed weights.

Because of this, the system and process of the present invention helps address the situation where a negative zero point error falls outside the correctable range of the process 60 of FIG. 3, such as the −4.0 kg to +4.0 kg range described above. If a negative zero point error outside the correctable range is encountered, the process of FIG. 4 may correct the error. This may occur, for example, where an object is placed on the seat and a small negative error (e.g., due to drift) follows. For example, a 5.0 kg object, such as a briefcase, may be placed on the seat and, subsequently, the sensor 14 may drift −1.5 kg. In this instance, the system 10 would read 3.5 kg.

The process 80 of FIG. 4 would not correct this negative drift because the sensed weight is positive. This sensed weight may, however, be within the correctable range (−4.0 kg to 4.0 kg) and, thus, the system 10 could mistake this for a zero point error and correct it (i.e., zero it out) via the process 60 of FIG. 3 after the vehicle ignition cycle ends. If the object is subsequently removed prior to the next ignition cycle, the system 10 would read negative (−5.0 kg) at the beginning of the next ignition cycle. In this situation, the process 60 of FIG. 3 would no longer correct the zero point error because the system 10 would perceive a zero point error outside the correctable range. According to the process 80 of FIG. 2 implemented in the system 10 of the present invention, this zero point error would still be corrected because it falls within the larger correctable range of the process (e.g., <0 kg and ≧−10 kg).

From the above description of the invention, those skilled in the art will perceive improvements, changes and modifications. Such improvements, changes and modifications within the skill of the art are intended to be covered by the appended claims.

Having described the invention, the following is claimed:

1. A process for adjusting the zero point of a system for sensing weight on a seat of a vehicle, the process comprising the steps of:
correcting only negative zero points errors during an ignition cycle of the vehicle; and
correcting positive zero point errors after the vehicle ignition cycle ends.

2. The process of claim 1, wherein said step of correcting only negative zero point errors comprises the steps of:
determining a sensed load on the vehicle seat;
determining a negative zero point error in response to determining a negative sensed weight on the vehicle seat; and
zeroing the sensed weight in response to determining the negative zero point error.

3. The process of claim 2, further comprising the step of repeating said steps of determining a sensed load, determining a negative zero point error, and zeroing the sensed weight throughout the duration of the ignition cycle.

4. The process of claim 2, wherein said step of zeroing the sensed weight comprises the step of zeroing the sensed weight in response to determining that the negative zero point error is within a predetermined range.

5. The process of claim 4, wherein said predetermined range is zero to −10 kilograms.

6. The process of claim 2, wherein said step of zeroing comprises zeroing the sensed weight in response to determining that the negative zero point error exists for at least a predetermined time.

7. The process of claim 6, wherein said predetermined time is at least 0.5 seconds.

8. The process of claim 2, wherein said step of determining a sensed weight comprises determining the sensed weight in response to an output of a seat weight sensor associated with the vehicle seat.

9. The process of claim 1, wherein said step of correcting positive zero point errors comprises the steps of:
determining an unoccupied condition of the vehicle seat;
determining a sensed load on the vehicle seat in response to determining the unoccupied condition of the vehicle seat;
determining a zero point error if the sensed load on the vehicle seat is within a predetermined range; and
zeroing the sensed weight in response to determining the zero point error.

10. The process of claim 9, wherein said predetermined range includes both positive and negative sensed loads.

11. The process of claim 9, wherein said predetermined range is −4.0 kilograms to +4.0 kilograms.

12. The process of claim 9, wherein said step of determining an unoccupied condition of the vehicle seat comprises at least one of the following steps:
determining that a predetermined amount of time has elapsed after the vehicle ignition cycle ends;
determining that a seat belt associated with the vehicle seat is in an unlatched condition; and
determining that the sensed load on the vehicle seat has not fluctuated for a predetermined amount of time after the vehicle ignition cycle ends.

13. A process for adjusting the zero point of a system for sensing weight on a seat of a vehicle, the process comprising the steps of:
determining a sensed load on the vehicle seat without regard to whether the seat is occupied;
determining a negative zero point error in response to determining a negative sensed weight on the vehicle seat;
zeroing the sensed weight in response to determining the negative zero point error; and
repeating said steps of determining a sensed load, determining a negative zero point error, and zeroing the sensed weight throughout an ignition cycle of the vehicle.

14. The process of claim 13, wherein said step of zeroing the sensed weight comprises the step of zeroing the sensed weight in response to determining that the negative zero point error is within a predetermined range.

15. The process of claim 14, wherein said predetermined range is zero to −10 kilograms.

16. The process of claim 13, wherein said step of zeroing comprises zeroing the sensed weight in response to determining that the negative zero point error exists for at least a predetermined time.

17. The process of claim 16, wherein said predetermined time is at least 0.5 seconds.

18. The process of claim 13, wherein said step of determining a sensed weight comprises determining the sensed weight in response to an output of a seat weight sensor associated with the vehicle seat.

19. The process of claim 13, further comprising the steps of:
determining an unoccupied condition of the vehicle seat at a predetermined time after the vehicle ignition cycle ends;
determining a sensed load on the vehicle seat in response to determining the unoccupied condition of the vehicle seat;
determining a zero point error if the sensed load on the vehicle seat is within a predetermined range; and
zeroing the sensed weight in response to determining the zero point error.

20. The process of claim 19, wherein said step of determining an unoccupied condition of the vehicle seat comprises at least one of the following steps:
determining that a predetermined amount of time has elapsed after the vehicle ignition cycle ends;
determining that a seat belt associated with the vehicle seat is in an unlatched condition; and
determining that the sensed load on the vehicle seat has not fluctuated for a predetermined amount of time after the vehicle ignition cycle ends.

21. The process of claim 19, wherein said predetermined range is −4.0 kilograms to +4.0 kilograms.

22. A vehicle seat weight sensing system comprising:
a seat weight sensor associated with a vehicle seat;
a controller operative to determine a sensed weight on the vehicle seat in response to an output from said seat weight sensor, said controller comprising:
means for correcting only negative zero points errors during an ignition cycle of the vehicle; and
means for correcting positive zero point errors after the vehicle ignition cycle ends.
